(19) United States
(12) Patent Application Publication
(10) Pub. No.: US 2007/0126745 A1
(43) Pub. Date: Jun. 7, 2007

(54) Method and system for displaying digital video

(75) Inventors: Jedy Wei, Taipei City (TW); Chin-Chung Yen, Taipei City (TW); Howard Cheng, Taipei City (TW)

Correspondence Address: CHARLES E. BAXLEY, ESQ., 90 JOHN STREET, THIRD FLOOR, NEW YORK, NY, 10038, US

(73) Assignee: Prolific Technology INC.

(21) Appl. No.: 11/294,768

(22) Filed: Dec. 5, 2005

(51) Int. Cl. G06T 1/60

(52) U.S. Cl. 345/530

(57) ABSTRACT

The present invention provides a method and system for displaying digital video. The CPU configures a space in the main memory for entries to record the displaying information in accordance with a video source in sequence and transfer the corresponding video data of the entries to the main memory. The flip controller informs the display controller to access the video data in the main memory in accordance the displaying information of the entries, and the display controller output the video data in the main memory to display in a screen.

### BACKGROUND OF THE PRESENT INVENTION

1. Field of Invention

The invention relates to a video displaying system, and more particularly to a portable digital video displaying system.

2. Description of Related Arts

To watch a DVD on a system, such as a personal computer, the burden of the CPU is very heavy. The CPU has to decode the video data of the content of the DVD to display on a screen, and also to take care of the flipping of the frames by mass calculation especially when dealing with the 3-2 pull down function or pausing function. It also consumes the memory space and power a lot. Therefore, it is not easy to design a low cost portable displaying system. A powerful CPU is needed to do the mass calculation, and then the power consumption cannot be decreased. If the CPU cannot deal with the heavy job, decoding and frame flipping, it may cause the synchronizing problem to have an unpleasant viewing experience.

If a low cost system is designed, the powerful CPU is not the choice for the system so that the price of the system can be cut down. Then we need to provide a new displaying method for the system with a lower performance CPU to decrease the burden of the CPU and the displaying quality still can be maintained.

### SUMMARY OF THE PRESENT INVENTION

A main object of the present invention is to provide a method to have an efficient way to displaying the digital video without worrying about the burden of the CPU.

Another object of the present invention is to design a low cost system for displaying digital video with a high performance.

Accordingly, in order to accomplish the one or some or all above objects, the system includes a CPU to configure a Flip Entry for displaying information and a data memory block to store the corresponding video content in a main memory, and a flip controller informs the display controller to access the video data in the main memory in accordance with the information in the Flip Entry, and then the video data is output to a display. In accordance with the present invention, the CPU does not need to deal with the flipping of the frames; therefore a functionally simple CPU can be employed to design a portable displaying system with low cost but having a high performance.

One or part or all of these and other features and advantages of the present invention will become readily apparent to those skilled in this art from the following description wherein there is shown and described a preferred embodiment of this invention, simply by way of illustration of one of the modes best suited to carry out the invention. As it will be realized, the invention is capable of different embodiments, and its several details are capable of modifications in various, obvious aspects all without departing from the invention. Accordingly, the drawings and descriptions will be regarded as illustrative in nature and not as restrictive.

### BRIEF DESCRIPTION OF THE DRAWINGS

FIG. 1 illustrates a displaying system according to a preferred embodiment of the present invention.

FIG. 2 illustrates a displaying system according to another preferred embodiment of the present invention.

FIG. 3 illustrates another displaying system according to another preferred embodiment of the present invention.

FIG. 4 illustrates an example of the entries and the corresponding frames according to the above preferred embodiment of the present invention.

FIG. 5 illustrates a process flow according to the above preferred embodiment of the present invention.

### DETAILED DESCRIPTION OF THE PREFERRED EMBODIMENT

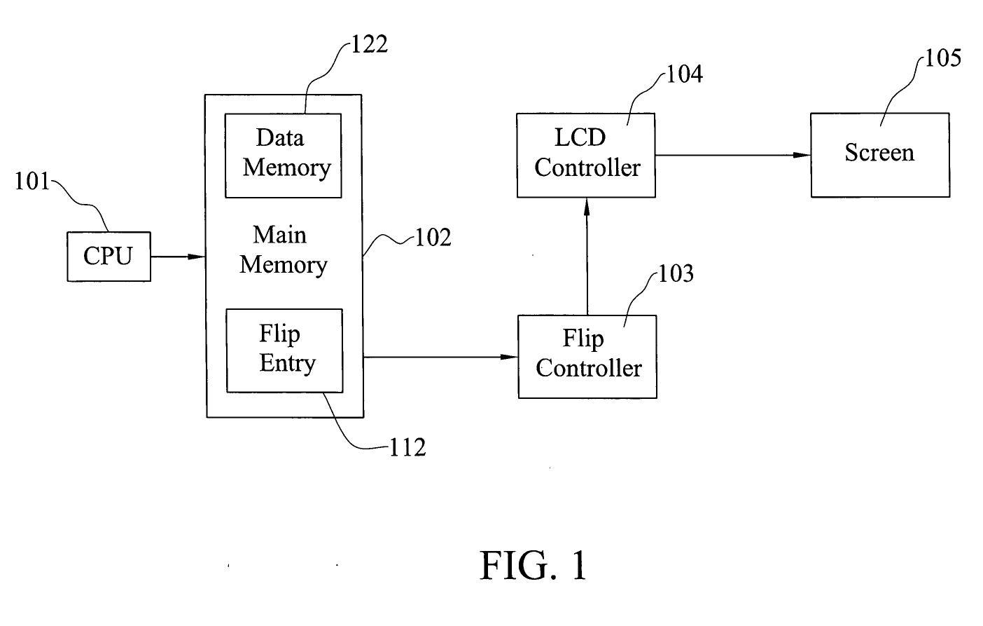

Referring to FIG. 1, a system for displaying digital video is illustrated as an embodiment of the invention. A digital video source is provided. It may come from a DVD, VCD, or even from the internet. The CPU 101 configures two memory blocks in the main memory 102 in accordance with video content of the digital video source. One is configured as a Flip Entry 112 including the information in the entries about the starting address of every frame of the video stored in the main memory, the size of every frame of the video, enlarging or shrinking the frame of the video, or whether pausing a frame of the video when needed.

The Flip Entry 112 may include 64 entries, from entry 0 to entry 63. The number of the entry depends on the need of the design, and any number is available. The CPU 101 produces the entries, fills the related information for the entries until the Flip Entry 112 is full, and also validates the entries in sequence, one at a time, in accordance with the video content, and the order of the entries is the displaying order of the video content. The video content is loaded to the data memory block 122 in the main memory 102. The video content includes video data in the corresponding frames. Only the necessary frames are loaded to the data memory block 122.

The starting memory address of every frame loaded to the data memory block 122 is recorded in the corresponding entry. The flip controller 103 reads the entry validated by the CPU 101, which is validated in accordance with the video content, and passes the corresponding frame of the validated entry to the display controller, like an LCD controller 104 from the data memory block 122. Then the LCD controller 104 outputs the frame to show in the screen in an appropriate format for the screen, such as an LCD 105.

After the corresponding frame is output to the screen, the validated entry is ready to be deleted, and the frame in the data memory block 122 can be deleted when there is no entry related to it. It is optional for the CPU 101 to refresh all of the entries at a time, or to refresh the entries partially as long as the Flip Entry 112 is not full. The refreshing of the frames in the data memory block 122 is accordance with the entries.

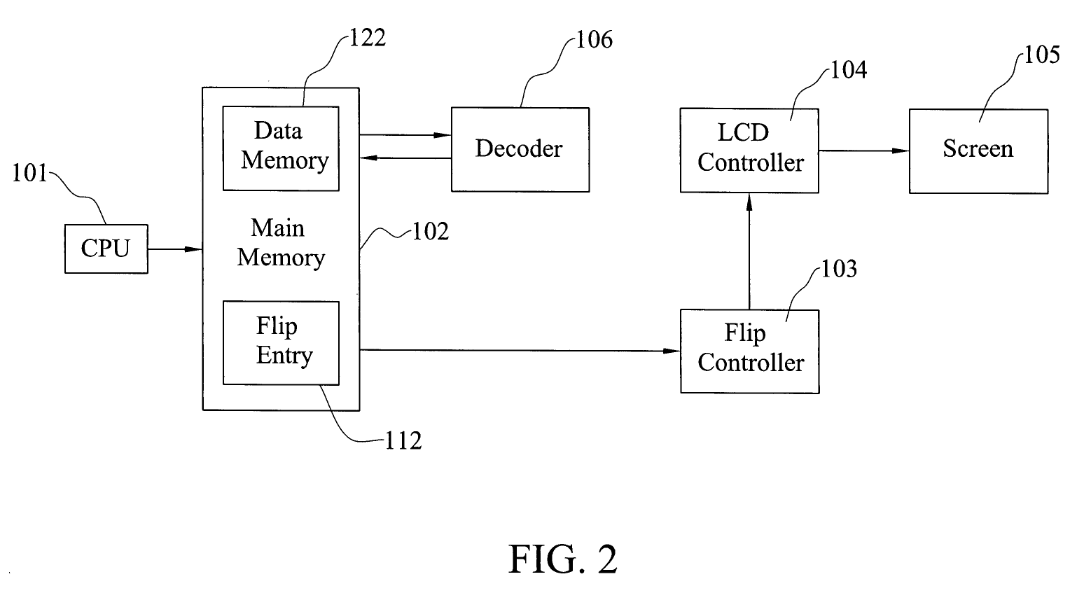

Referring to FIG. 2, another embodiment of the invention is illustrated. The system is almost the same as the previous embodiment except there is a decoder 106 between the main memory 102 and the LCD controller 104. When the video data stored in the main memory is not RGB format, such as the YUV format, the decoder 106 is needed to decode the video data so that the content of the video source can be displayed on the LCD 105 at last. The decoded video data are stored back to the main memory 102 and passed to the flip controller 103 accompanying with the corresponding entry of the decoded video data. And then the decoded data are displayed on the LCD 105 through the LCD controller 104. The decoder may be a circuit dedicated to decode only, or the CPU 101 may execute the decoding function for the system.

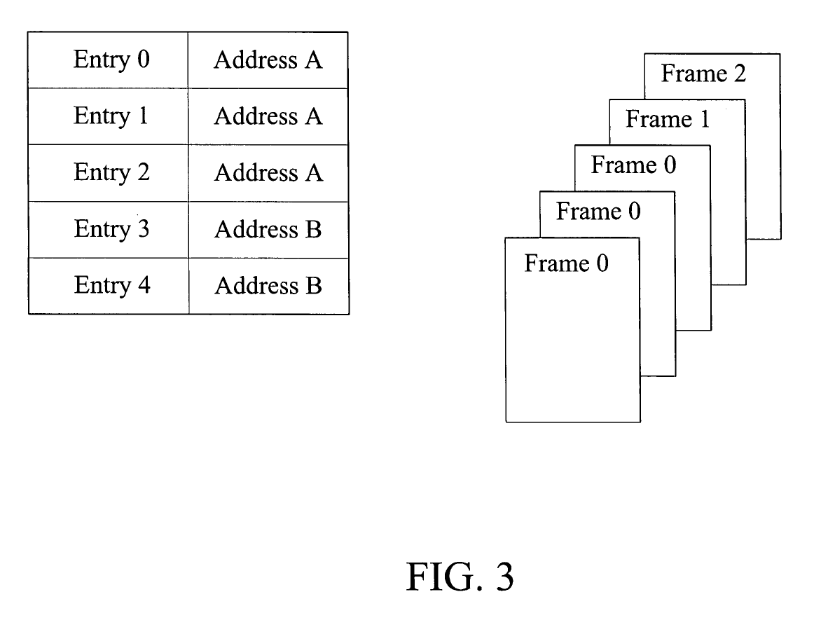

If the different entries relate to the same corresponding frame, only one corresponding frame is loaded to the data memory block. Referring to FIG. 3, frame0, starting from address_0 in the main memory, needs to be played for 3 times to implement 3-2 pull down function. And the following to be played are frame_1 and frame_2. The entry_0, entry_1 and entry_2 all record the same starting address, address_A, of the frame_0. Then entry_3 records the starting address, address_B, of the frame1, and entry3 records the starting address, address_C, of the frame2 in sequence.

There are 5 frames need to be played but only 3 frames need to be loaded to the memory. Therefore, the 3-2 pull down function is very easily to be implemented in accordance with the invention. The CPU's burden and the needed memory can be reduced.

The entry also includes the information about scaling. It can indicate whether to enlarge or shrink the fame. By repeating the particular lines of the frame, like repeating the same video data every other line, the frame can be enlarged. And by deleting the particular lines of the frame, like deleting the video data every other line, the frame can be shrunk. In accordance with the invention, there is no complicated calculation of the CPU for scaling the frame, and there is no need to prepare a mass memory space for the calculation. It is only done by repeating or deleting the video data of the frame.

When the CPU receives a signal to pause the picture of the screen, a corresponding entry is provided to indicate the corresponding entry has to be repeated over and over again, and only the corresponding frame stored in the main memory can be output to the screen, until another signal received to cancel the pausing.

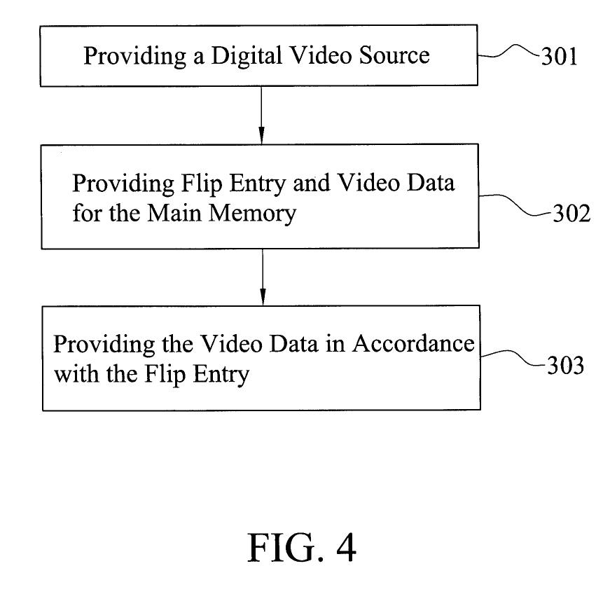

FIG. 4 illustrates the process flow for displaying the digital video. In step 301, a digital video source is provided. The digital video source may come from a DVD, VCD or even the internet. In step 302, in accordance with the content of the video source in sequence, two memory spaces are configured in a main memory. One is for Flip Entry, and another is the data memory block for the video data of the frames of the video source.

The entries of the Flip Entry includes the information about the starting address of every frame of the video stored in the main memory, the size of every frame of the video, enlarging or shrinking the frame of the video, or whether pausing a frame of the video when needed. The number of the entries is not restricted. It depends on the need of the design.

The entries include the starting memory addresses of the corresponding frames, and also record the size of the corresponding frames. For the data in the memory, the end of the frame is decided by the size and the starting memory address of the corresponding entry. Therefore, based on the above information, the video data is output to be displayed in a screen frame by frame, as the step 303.

The entries are produced in sequence in accordance with the video content, and the related information is filled for every entry until the Flip Entry is full. When the entry is produced, the corresponding frame is also loaded to the data memory block. After the corresponding frame is output to the screen, the read entry is ready to be deleted, and the frame in the data memory block can be deleted when there is no entry related to it. It is optional to refresh all of the entries at a time, or to refresh the entries partially as long as the Flip Entry is not full. The refreshing of the frames in the data memory block is accordance with the entries. If the different entries relate to the same corresponding frame, only one corresponding frame is loaded to the data memory block.

The entry also includes the information about scaling. It can indicate whether to enlarge or shrink the fame. By repeating the particular lines of the frame, like repeating the same video data every other line, the frame can be enlarged. And by deleting the particular lines of the frame, like deleting the video data every other line, the frame can be shrunk. In accordance with the invention, there is no complicated calculation of the CPU for scaling the frame, and there is no need to prepare a mass memory space for the calculation. It is only done by repeating or deleting the video data of the frame.

One skilled in the art will understand that the embodiment of the present invention as shown in the drawings and described above is exemplary only and not intended to be limiting.

The foregoing description of the preferred embodiment of the present invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A method for displaying digital video, comprising:
providing a digital video source;
sequentially providing a plurality of new information sets and a plurality of first corresponding video data sets in accordance with said digital video source for a memory, and deleting a plurality of said old information sets and a plurality of said second corresponding data sets from said memory; and
reading said new information sets in sequence and displaying said first corresponding video data sets on a screen from said memory.

2. The method for displaying digital video according to the claim 1, wherein each of said video data sets comprises a plurality of data of a frame of said digital video source.

3. The method for displaying digital video according to the claim 1, wherein each of said new information sets comprises a plurality of video displaying informations of said new corresponding video data set, and each of said old information sets comprises a plurality of video displaying informations of said old corresponding video data set

4. The method for displaying digital video according to the claim 3, wherein said video displaying informations comprise a starting address of said video data set in said memory, a size of said video data set, enabling to scale, or enabling to repeat.

5. The method for displaying digital video according to the claim 4, wherein said enabling to scale comprises a scaling information for enlarging or shrinking when displaying said second corresponding data sets on said screen.

6. The method for displaying digital video according to the claim 4, wherein said enabling to repeat comprises a repeat information for pausing when displaying said second corresponding data sets on said screen.

7. The method for displaying digital video according to the claim 1, wherein providing a plurality of new information sets and a plurality of first corresponding video data sets in accordance with said digital video source for a memory includes configuring a first space of said memory to store a plurality of said information sets and configuring a second space of said memory to store a plurality of said corresponding video data sets.

8. The method for displaying digital video according to the claim 1, wherein providing said new information sets are stopped for said first space of said memory and providing said first corresponding video data sets are stopped for said second space of said memory when said first space of said memory is full.

9. The method for displaying digital video according to the claim 1, wherein any of said new information sets turns into a corresponding old information set after said new information set is read.

10. The method for displaying digital video according to the claim 1, wherein each of said old information sets in said first space of said memory is deleted after said second corresponding video data set is displayed on said screen.

11. The method for displaying digital video according to the claim 1, wherein said second corresponding video data set in said second space of said memory is deleted when each of said new information set has no displaying informations of said corresponding video data set.

12. A system for displaying digital video, comprising:
a processor;
a memory electrically connected to said processor;
a first controller electrically connected to said memory; and
a second controller electrically connected to said memory and said first controller, wherein said processor sequentially forms a plurality of information sets in accordance with a digital video source and sequentially transfers a plurality of corresponding video data sets in accordance with a plurality of said information sets from said digital video source to said memory, said first controller reads a plurality of said information sets from said memory in sequence and passes a plurality of said corresponding video data sets to said second controller, and said second controller adjusts a plurality of said corresponding video data sets in an appropriate format to output to a screen to display.

13. The system for displaying digital video according to the claim 12, wherein said processor configures a first space in said memory to store a plurality of said information sets, and configures a second space in said memory to store a plurality of said corresponding video data sets.

14. The system for displaying digital video according to the claim 12, wherein said video data set comprises a plurality of data of a frame of said digital video source.

15. The system for displaying digital video according to the claim 12, wherein each of said information set comprises a plurality of displaying informations of said corresponding video data set.

16. The system for displaying digital video according to the claim 15, wherein each of said video displaying informations comprises a starting address of said video data set in said memory, a size of said video data set, enabling to scale, and enabling to repeat.

17. The method for displaying digital video according to the claim 16, wherein said enabling to scale comprises a scaling information for enlarging or shrinking when displaying said corresponding data sets on said screen.

18. The method for displaying digital video according to the claim 16, wherein said enabling to repeat comprises a repeat information for pausing when displaying said corresponding data sets on said screen.

19. The system for displaying digital video according to the claim 12, wherein said first controller reads a next information set after said second controller ends outputting said corresponding video data set of a current information set.

20. The system for displaying digital video according to the claim 12, wherein said processor stops forming any of said information sets and stops transferring any of said corresponding video data sets when said first space of said memory is full.

21. The system for displaying digital video according to the claim 12, wherein each of said information sets is deleted after being read by said first controller.

22. The system for displaying digital video according to the claim 12, wherein said corresponding video data sets is deleted when any of said information set has no displaying informations of said corresponding video data set.

23. The system for displaying digital video according to the claim 12, further comprising a decoder to decode said corresponding video data sets from said memory in accordance with said information set read by said first controller and output said decoded video data set to back to said memory.

24. The system for displaying digital video according to the claim 12, wherein the processor decodes said corresponding video data sets from said memory in accordance with said information set read by said first controller and output said decoded video data set to said second controller.

25. The system for displaying digital video according to the claim 12, wherein said processor decodes said corresponding video data set from said second controller in accordance with said information set read by said first controller and output a plurality of said decoded video data sets to said screen.
